(19) United States
(12) Patent Application Publication
(10) Pub. No.: US 2025/0173878 A1
(43) Pub. Date: May 29, 2025

(54) IMAGE PROCESSING METHOD AND APPARATUS, ELECTRONIC DEVICE, AND STORAGE MEDIUM

(71) Applicant: Beijing Bytedance Network Technology Co., Ltd., Beijing (CN)

(72) Inventors: Peng Zhang, Beijing (CN); Jie Wu, Beijing (CN); Zhichao Liu, Beijing (CN)

(21) Appl. No.: 18/714,047

(22) PCT Filed: Nov. 29, 2022
(86) PCT No.: PCT/CN2022/134908

§ 371 Date: May 28, 2024

(30) Foreign Application Priority Data
Nov. 29, 2021 (CN) 202111436164.5

(51) Int. Cl. G06T 7/246; G06T 15/02; G06T 15/20; G06T 19/20

(52) U.S. Cl. CPC G06T 7/251; G06T 15/02; G06T 15/205; G06T 19/20; G06T 2200/08; G06T 2207/20081; G06T 2207/20084; G06T 2207/20221; G06T 2207/30201; G06T 2219/2004; G06T 2219/2024

(57) ABSTRACT

Embodiments of the present disclosure provide an image processing method and apparatus, an electronic device, and a storage medium. The method includes: obtaining, in response to a special effect trigger operation, an image to be processed that includes a target subject; and determining facial attribute information of the target subject, and fusing a target special effect matching the facial attribute information for the target subject, to obtain a target special effect image corresponding to the image to be processed.

### CROSS-REFERENCE TO RELATED APPLICATIONS

The present disclosure claims priority to Chinese Patent Application No. 202111436164.5, filed with the China National Intellectual Property Administration on Nov. 29, 2021, which is incorporated herein by reference in its entirety.

### TECHNICAL FIELD

Embodiments of the present application relate to the field of image processing technologies, for example, to an image processing method and apparatus, an electronic device, and a storage medium.

### BACKGROUND ART

With the development of network technologies, an increasing number of applications are coming into life of users, especially a range of software applications that can be used to shoot short videos, which are popular among users.

In order to improve the user experience, corresponding special effects may be added to the users in the videos. In the related art, the addition of special effects is implemented by 3D stickers, i.e., by matching the 3D stickers with human faces. The attached special effects are prone to goofs and shakes, resulting in a poor addition result of special effects, poor reality, and poor user experience. In other words, the special effects are mechanically added to the users, resulting in poor adaptability.

### SUMMARY OF THE INVENTION

The present application provides an image processing method and apparatus, an electronic device, and a storage medium to achieve a high matching degree between a special effect and a user after fusion, thereby improving the user experience.

According to a first aspect, an embodiment of the present application provides an image processing method. The method includes:
obtaining, in response to a special effect trigger operation, an image to be processed that includes a target subject; and
determining facial attribute information of the target subject, and fusing a target special effect matching the facial attribute information for the target subject, to obtain a target special effect image corresponding to the image to be processed.

According to a second aspect, an embodiment of the present application further provides an image processing apparatus. The apparatus includes:
an image-to-be-processed acquisition module configured to obtain, in response to a special effect trigger operation, an image to be processed that includes a target subject; and
a special effect image determining module configured to determine facial attribute information of the target subject, and fuse a target special effect matching the facial attribute information for the target subject, to obtain a target special effect image corresponding to the image to be processed.

According to a third aspect, an embodiment of the present disclosure further provides an electronic device. The electronic device includes:
a processor; and
a storage apparatus configured to store a program, where
the program, when executed by the processor, causes the processor to implement the image processing method according to any one of the embodiments of the present disclosure.

According to a fourth aspect, an embodiment of the present disclosure further provides a storage medium including computer-executable instructions, where the computer-executable instructions, when executed by a computer processor, are used to perform the image processing method according to any one of the embodiments of the present disclosure.

According to a fifth aspect, an embodiment of the present disclosure further provides a computer program product which, when executed by a computer, causes the computer to implement the image processing method according to any one of the embodiments of the present disclosure.

### BRIEF DESCRIPTION OF DRAWINGS

Throughout the drawings, the same or similar reference numerals denote the same or similar elements. It should be understood that the drawings are schematic and that parts and elements are not necessarily drawn to scale.

FIG. 1 is a schematic flowchart of an image processing method according to Embodiment 1 of the present disclosure;

FIG. 2 is a schematic flowchart of an image processing method according to Embodiment 2 of the present disclosure;

FIG. 3 is a schematic flowchart of an image processing method according to Embodiment 3 of the present disclosure;

FIG. 4 is a schematic diagram of a structure of an image processing apparatus according to Embodiment 4 of the present disclosure; and

FIG. 5 is a schematic diagram of a structure of an electronic device according to Embodiment 5 of the present disclosure.

### DETAILED DESCRIPTION OF THE INVENTION

Embodiments of the present disclosure are described below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are for exemplary purposes only.

It should be understood that the various steps described in the method implementations of the present disclosure may be performed in different orders, and/or performed in parallel. Furthermore, additional steps may be included and/or the execution of the illustrated steps may be omitted in the method implementations.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish between different apparatuses, modules, or units, and are not used to limit the sequence or interdependence of functions performed by these apparatuses, modules, or units.

It should be noted that the modifiers “one” and “a plurality of” mentioned in the present disclosure are illustrative, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Before the technical solutions are described, an exemplary description may be given to the application scenario. The technical solutions of the present disclosure may be applied to pictures requiring the display of special effects. For example, in video calls, special effects may be displayed; or in live streaming scenes, special effects may be displayed for live streamers. Certainly, the technical solutions may also be applied to the process of video shooting in which special effects may be displayed for images corresponding to subjects, such as in short video shooting scenes.

In the embodiments, the added special effects may be various pet head simulation special effects. For example, if a cat-woman special effect is desired, the pet head simulation special effect may be a special effect that simulates the head of a real cat, and the special effect that simulates the head of the real cat is fused with a face image of a user to obtain a final cat-woman special effect. Certainly, if a rabbit special effect is desired, a special effect of the head of a real rabbit may be simulated, and the simulated special effect of the head of the real rabbit is fused with the face image of the user to obtain a rabbit special effect.

That is, in the technical solutions provided in the embodiments of the present disclosure, the target special effect fused for the user may be at least one of a pet head simulation special effect, an animal head simulation special effect, a cartoon image simulation special effect, a fluff simulation special effect, and a hairstyle simulation special effect to be fused with the face image.

### Embodiment 1

FIG. 1 is a schematic flowchart of an image processing method according to Embodiment 1 of the present disclosure. This embodiment of the present disclosure is applicable to a case of processing a face image of a target object into a special effect image for display in any image display scene supported by the Internet. The method may be performed by an image processing apparatus. The apparatus may be implemented in the form of software and/or hardware, and optionally, by an electronic device, which may be a mobile terminal, a personal computer (PC), a server, etc. The image display scene is usually implemented by a client and a server in combination. The method provided in this embodiment may be performed by the server, or by the client, or by the client and the server in combination.

As shown in FIG. 1, the method includes the following steps.

S110: Obtain, in response to a special effect trigger operation, an image to be processed that includes a target subject.

Optionally, the apparatus for performing the image processing method provided in this embodiment of the present disclosure may be integrated into application software supporting an image processing function, and the software may be installed in an electronic device. Optionally, the electronic device may be a mobile terminal, a PC, etc. The application software may be a kind of software for image or video processing, as long as image or video processing can be implemented. Alternatively, the application software may be a specially developed application, which is implemented in software for adding and displaying special effects, or is integrated into a corresponding page, so that a user may add special effects through the page integrated into the PC.

In an embodiment, the image to be processed may be an image acquired based on the application software or an image pre-stored by the application software from storage space. In practical application, an image including the target subject may be captured in real time based on the application software, in which case a special effect may be directly added for a user. Alternatively, when it is detected that the user triggers a special effect adding control, the image is sent to the server, and the server adds the special effect to the target subject in the acquired image to be processed. In a shooting scene, there may be a plurality of subjects in the camera. For example, in a scene with a high crowd density, there may be a plurality of users in the camera, and the users in the camera may be used as target subjects. Alternatively, one or more of the users may be marked as the target subjects before special effects are added, and accordingly, the special effects may be added subsequently to the target subjects.

For example, when it is detected that a special effect needs to be added to the target subject in the image to be processed, the image to be processed that includes the target subject may be acquired to add the special effect to the target subject in the image to be processed, thereby obtaining a target special effect image corresponding to the image to be processed.

In this embodiment, the special effect trigger operation includes at least one of the following: triggering a special effect processing control; detecting voice information including a special effect adding instruction; detecting that a display interface includes a face image; and detecting that, in a field of view corresponding to a target terminal, a body movement of the target subject is the same as a preset special effect feature.

For example, the special effect processing control may be a key displayed on the display interface of the application software, and the triggering of the key represents that the image to be processed needs to be acquired and special effect processing needs to be performed on the image to be processed. In practical application, if the user triggers the key, it may be considered that an image function of special effect display is to be triggered, i.e., a corresponding special effect needs to be added to the target subject. The added special effect may be consistent with the special effect triggered by the user. Alternatively, the voice information is acquired based on a microphone array deployed on a terminal device, and is analyzed. If a processing result includes a word for adding a special effect, it indicates that a special effect adding function is triggered. It can be understood that determining whether to add a special effect based on the content of the voice information avoids interaction between the user and a display page, which improves the intelligence of special effect addition. Another implementation may be determining, based on a shooting field of view of a mobile terminal, whether the body movement of the target subject in the field of view is consistent with a preset body movement. Based on a determination result that the body movement of the target subject in the field of view is consistent with the preset body movement, it indicates that the special effect adding operation is triggered. For example, when the preset body movement is a “victory” posture, it indicates that the special effect trigger operation is triggered if the body movement of the target subject triggers the victory posture. In other embodiments, various special effect props may be downloaded in advance, and the special effect trigger operation is triggered when it is mainly detected that a face image is included in a field of view of a shooting apparatus.

In an embodiment, the preset subject movement matching the added special effect may also be understood that different special effects correspond to different body movements. The preset body movement in this technical solution may be a movement of wearing a crown or a movement of imitating a little animal, and the imitated little animal may be used as the added special effect, which improves the intelligence of identification and addition of the special effect.

It should be noted that, whether in a live streaming scene or in an image processing scene, an image may be acquired in real time if there is a need to acquire a target object in a target scene in real time, and the image acquired at this time may be used as an image to be used. Accordingly, the image to be used may be analyzed, and a corresponding image after the special effect adding function is triggered may be used as the image to be processed.

S120: Determine facial attribute information of the target subject, and fuse a target special effect matching the facial attribute information for the target subject, to obtain a target special effect image corresponding to the image to be processed.

Optionally, the facial attribute information may be face deflection angle information of the target subject. In order to match the same special effect and different facial attribute information, the contents of the same special effect in different facial attributes may be preset. The facial attribute information may be stored in a special effect set, i.e., a plurality of special effects may be stored in the special effect set, with different special effects corresponding to different face deflection angles. A special effect that is consistent with the facial attribute information of the target subject or that has a deflection angle error within a preset error range may be obtained from the special effect set as the target special effect. The target special effect image may be a special effect image obtained by fusing the target special effect and the target subject.

For example, after the image to be processed is obtained, the facial attribute information of the target subject, i.e., the face deflection angle information of the target subject, may be determined. The face deflection angle information is mainly deflection angle information of the user's face relative to the shooting device. The target special effect consistent with the face deflection angle information may be determined, and after the target special effect is determined, the target special effect and the target subject may be fused to obtain the target special effect image with the target special effect added to the target subject in the image to be processed.

For example, if a cat-woman special effect needs to be added to the target subject in the image to be processed and the face deflection angle is 0 degrees, the target special effect may be a target special effect corresponding to the face deflection angle of 0 degrees, or a target special effect having a difference between a face deflection angle thereof and a face deflection angle of a special effect in the special effect set within a preset error range. Optionally, the preset error range may be within 1 degree. It should be noted that it is within the scope of protection of this technical solution as long as animal simulation special effects or head simulation special effects are added to the head of a target user.

It should be noted that the foregoing is merely an exemplary description, and the target special effect provided in this embodiment of the present disclosure includes at least one of a pet head simulation special effect, an animal head simulation special effect, a cartoon image simulation special effect, a fluff simulation special effect, and a hairstyle simulation special effect to be fused with the face image.

In the technical solution of this embodiment of the present disclosure, the image to be processed that includes the target subject is obtained in response to the special effect trigger operation; and the facial attribute information of the target subject is determined, and the target special effect matching the facial attribute information is fused for the target subject to obtain the target special effect image, which solves the problems that in adding special effects in the related art, mainly by attaching 3D stickers, a poor special effect is generated due to poor fitness; and that corresponding special effects are mechanically added, resulting in a low reality of the special effects. The present application achieves technical effects of adding corresponding target special effects to users based on facial attribute information, improving the matching degree between the special effects and the users, and further improving the user experience.

### Embodiment 2

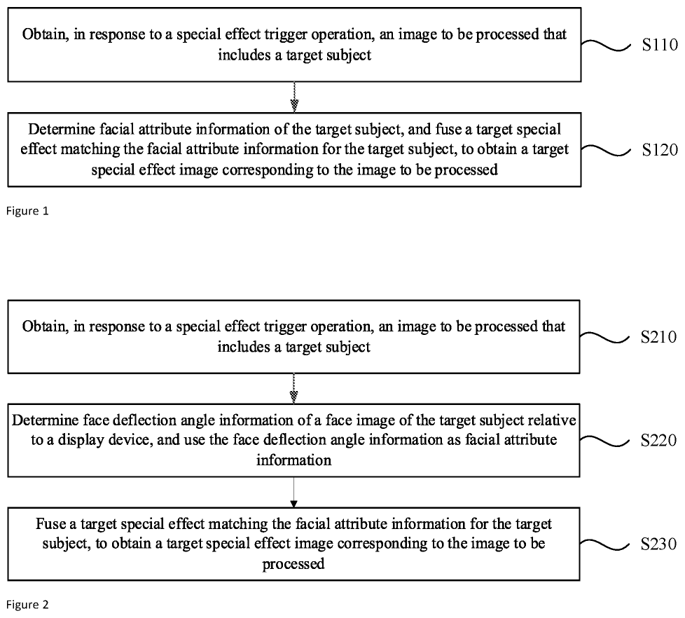

FIG. 2 is a schematic flowchart of an image processing method according to Embodiment 2 of the present disclosure. On the basis of the above embodiment, the special effect may be added to the target subject in the image to be processed by the server or the client. The added special effect may be implemented by a corresponding algorithm, and for specific implementation thereof, reference may be made to the detailed description of this technical solution, where the technical terms that are identical or corresponding to those in the above embodiment are not repeated herein.

As shown in FIG. 2, the method includes the following steps.

S210: Obtain, in response to a special effect trigger operation, an image to be processed that includes a target subject.

S220: Determine face deflection angle information of a face image of the target subject relative to a display device, and use the face deflection angle information as facial attribute information.

Based on the foregoing, it can be known that the facial attribute information includes a face deflection angle. The face deflection angle is mainly a deflection angle of a user's face relative to a shooting device, which is, in terms of a camera apparatus on a terminal device, a relative deflection angle between the user and the camera apparatus. The face deflection angle information may include any angle from 0 to 360 degrees. Being relative to the display device may be understood as being relative to the camera apparatus in the display device. The face image is mainly the face image of the target subject.

For example, after the image to be processed is obtained, the face deflection angle information of the face image of the target subject relative to the camera apparatus in the display device can be determined by using a corresponding algorithm. The reasons for determining the face deflection angle information are as follows. Mainly, for fusing of a target special effect and the face image of the target subject, in order to improve the reality and fitness of the fusion result, the corresponding target special effect may be determined with reference to the facial attribute information of the user, such that the fusion is performed to achieve the corresponding fusion effect.

In this embodiment, the determining face deflection angle information of a face image of the target subject relative to a display device includes: determining, based on a predetermined target center line, a deflection angle of the face image relative to the target center line, and using the deflection angle as the face deflection angle information, where the target center line is determined based on a historical face image, and face deflection angle information of the historical face image relative to the display device is less than a preset deflection angle threshold; or segmenting the face image based on a preset grid, and determining the face deflection angle information of the face image relative to the display device based on a segmentation result; or performing angle registration on the face image and all face images to be matched, to determine a target face image to be matched that corresponds to the face image, and using a face deflection angle of the target face image to be matched as the face deflection angle information of the target subject, where all the face images to be matched respectively correspond to different deflection angles, and a set of the different deflection angles covers 360 degrees; or recognizing, based on a pre-trained face deflection angle determining model, the image to be processed to determine the face deflection angle information of the target subject.

It may be understood that there are four possible implementations for determining the face deflection angle information.

A first implementation may be as follows: A plurality of historical face images are obtained, each having a face deflection angle relative to the display device that is less than the preset deflection angle threshold. The face deflection angle may be denoted as 0 degrees when a plane to which the face belongs is parallel to a plane to which the display device belongs. The preset deflection angle threshold may be 0 to 5 degrees. The plurality of historical face images of this type may be obtained. A center line connected by a center between the eyebrows, a tip of the nose, and the philtrum is determined for each historical face image. After the center lines of all the historical face images are determined, all the historical face images are aligned and all the center lines are fitted to obtain a target center line. Alternatively, there may be some differences in sizes of faces corresponding to the historical face images. In this case, a target center line may be determined for the same face size, and there may be a plurality of determined target center lines. After the face image is obtained, a target historical face image having a consistent size with the face image may be determined from the historical face images, and a center line of the target historical face image may be used as the target center line. After the center line is determined, a deflection angle of the face image relative to the center line may be determined, thereby obtaining the face deflection angle information.

A second implementation may be as follows: The face image may be placed in a preset grid, and the face deflection angle information may be determined based on facial information in each preset grid. The preset grid may be a nine-square grid, a twelve-square grid, a sixteen-square grid, etc. For example, the face image is placed in a standard nine-square grid, and the face image may be segmented based on the standard nine-square grid. A deflection angle corresponding to each square is determined based on a preset segmentation result when the face deflection angle information is 0 degrees, and a mode among the deflection angles is used as the face deflection angle information. Alternatively, the deflection angles of the squares are fitted to obtain the face deflection angle information. The deflection angle of each square may be determined by matching a corresponding feature point.

A third implementation may be as follows: Images of the same user or different users at different face deflection angles are obtained in advance as face images to be matched. Different images to be matched correspond to different face deflection angles, and a set of the different face deflection angles may cover 360 degrees. The face images to be matched may be determined based on a preset deflection angle step size. Optionally, the preset deflection angle step size may be 0.5 degree, where 720 images to be matched may be stored. Alternatively, the preset deflection angle step size may be 2 degrees, where 180 images may be stored. The deflection angle step size matches an actual requirement. After the face image of the target subject is determined, angle registration may be performed on the face image and the face images to be matched to determine the most matching image to be matched, and a face deflection angle of the determined image to be matched is used as the face deflection angle information of the image to be processed.

A fourth implementation may be as follows: A face deflection angle determining model may be pre-trained, and the model can determine the deflection angle of the face image in the image to be processed. For example, the image to be processed may be input into the face deflection angle determining model to obtain the face deflection angle information corresponding to the target subject in the image to be processed.

S230: Fuse a target special effect matching the facial attribute information for the target subject, to obtain a target special effect image corresponding to the image to be processed.

Optionally, a target fusion special effect model consistent with the facial attribute information is obtained from all fusion special effect models to be selected, where all the fusion models to be selected respectively correspond to different face deflection angles and are consistent with the target special effect; and the target fusion special effect model and the face image of the target subject are fused to obtain the target special effect image in which the target special effect is fused for the target subject.

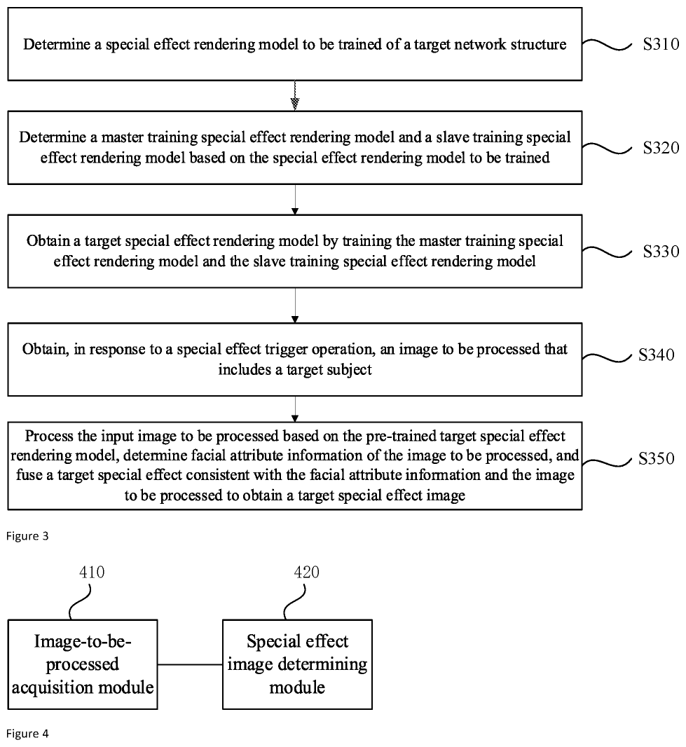

In an embodiment, fusion special effect models to be selected consistent with different facial attribute information may be provided according to actual needs. Referring to FIG. 3, a 3D special effect model may be provided that is consistent with the coat of a real animal, i.e., a pet or animal simulation special effect. In addition, special effect models with different angles may be provided, where the different angles are consistent with the facial attribute information. That is, if the facial attribute information includes deflections of 0 to 360 degrees, there will be 360 fusion special effect models to be selected. That is, a plurality of special effect fusion models to be selected are constructed in advance by using a 3D rendering technology. The facial attribute information corresponding to the target subject is unique, and therefore, after the facial attribute information of the target subject is determined, the target fusion special effect model may be determined from all the fusion special effect models to be selected, based on the face deflection angle corresponding to the facial attribute information. That is, the target fusion special effect model is a special effect model that is consistent with the facial attribute information in the image to be processed. After the target fusion special effect model is determined, the target fusion special effect model and the face image of the target subject may be fused to obtain the target special effect image in which the target special effect is fused for the target subject. In this case, the target special effect is mainly consistent with the special effect triggered by the user.

In order to determine how the face image and the target fusion special effect model are fused to obtain the target special effect image, reference may be made to the following description. A head image of the target subject is extracted, and the head image is fused into a target position in the target fusion special effect model to obtain a special effect image to be corrected; and pixels to be corrected in the special effect image to be corrected are determined, and the target special effect image is obtained by compressing the pixels to be corrected or replacing pixel values thereof, where the pixels to be corrected include pixels corresponding to hair that is not covered by the target special effect and pixels on an edge of the face image that do not fit a target fusion special effect.

In an embodiment, the special effect image to be corrected includes the face image and the target special effect where the hair is partially or fully covered by the target special effect. Alternatively, the special effect image to be corrected includes an image that is not fully fused when the head image and the target fusion special effect model are fused.

It may be understood that in order to fully fuse the target special effect fusion model and the target subject, the head image of the target subject may be obtained by using an image segmentation algorithm. The head image in this case includes not only a hair image but also a face image. That is, the head image is obtained after obtaining a head contour image by segmentation. The target fusion special effect model is a 3D model, where false face information may be placed in the 3D model, and a position corresponding to the false face information is the target position. The face image in the head image may be overlapped with the target position, where the hair area is covered by a special effect part in the 3D special effect model. The false face information may be the facial image in the 3D model. In practical application, there may be a case in which the special effect does not fully cover the hair or the face image and the special effect do not fully fit each other. Therefore, the image obtained after direct fusion with the 3D special effect model is used as the special effect image to be corrected. The pixels in the hair area that is not fully covered by the special effect and the pixels of the face image that do not fully fit the special effect are used as the pixels to be corrected. The pixels to be corrected in the hair area may be compressed, i.e., the hair area may be compressed to become smaller, such that the hair is fused with the special effect. In addition, the pixels of the face image that do not fully fit the special effect may be deformed to obtain the fused target special effect image. Alternatively, pixel values of pixels in an area adjacent to the pixels to be corrected may be obtained, and pixel values of the pixels to be corrected may be replaced with the obtained pixel values to obtain the target special effect image.

In this embodiment, the target fusion special effect model and the face image of the target subject being fused to obtain the target special effect image in which the target special effect is fused for the target subject may further include: determining at least one fusion key point in the target fusion special effect model and a corresponding target key point on the face image, to obtain at least one key point pair; and determining a distortion parameter based on the at least one key point pair, so as to adapt the target fusion special effect model to the face image based on the distortion parameter, to obtain the target special effect image.

In an embodiment, the target fusion special effect model includes a model image, and a key point, in the model image, corresponding to the face image may be used as the fusion key point. For example, positions where the eyebrows are located in the target fusion special effect during attachment may be mainly used as fusion key points. After the fusion key points are determined, the target key points on the face image may be obtained. For example, key points corresponding to the eyebrows are the target key points. Based on this, a plurality of key point pairs may be obtained, each including a fusion key point and a target key point corresponding to the same position. A deformation parameter, i.e., the distortion parameter, of each part may be determined based on the key point pairs, and the fusion degree between the face image and the target fusion special effect model may be adjusted based on the distortion parameter, so as to obtain the target special effect image.

In the technical solution of this embodiment of the present disclosure, the method may be deployed either on a mobile terminal or on a server. The facial attribute information of the target subject is determined based on the corresponding algorithm, and the corresponding target special effect is added to the target subject, which improves the adaptability of the added target special effect, thereby improving the user experience.

### Embodiment 3

FIG. 3 is a schematic flowchart of an image processing method according to Embodiment 3 of the present disclosure. On the basis of the above embodiments, the target special effect may be added to the target subject in the image to be processed based on a pre-trained target special effect rendering model to obtain the target special effect image, where the technical terms that are identical or corresponding to the above technical terms are not repeated herein.

As shown in FIG. 3, the method includes the following steps.

It should be noted that in order to adapt the display of special effects to a terminal, a model may be pre-trained and deployed on the terminal device, such that when an image is captured based on the terminal device, a special effect image corresponding to the image may be quickly used for response.

S310: Determine a special effect rendering model to be trained of a target network structure.

It should be further noted that in order to improve the universality of application of the special effects, a model with a small amount of computation and a good processing effect may be obtained and deployed on the terminal device. Therefore, a model structure corresponding to a neural network may be selected before the model is trained. The special effect rendering model to be trained of the target network structure may be evaluated and determined from two dimensions, where one dimension is the amount of computation of the model being deployed on the terminal device, and the other dimension may be the processing effect of the model.

Optionally, the determining a special effect rendering model to be trained of a target network structure includes: obtaining at least one special effect fusion model to be selected, where the special effect fusion model to be selected has a different network structure, the special effect fusion model to be selected includes a convolutional layer, and the convolutional layer includes at least one convolution each including a plurality of channel numbers; and determining the special effect rendering model to be trained of the target network structure based on an amount of computation and an image processing effect of the at least one special effect fusion model to be selected, where the image processing effect is evaluated by a similarity between an output image and an actual image under a condition that model parameters in the at least one special effect fusion model to be selected are unified.

The model structure of the neural network may be determined by adjusting the number of channels of the convolution in the convolutional layer in the neural network. The convolutional layer includes a plurality of convolutions each including a channel number indicator, and different channel numbers can be set. Typically, in order to meet data processing requirements of a computer, the channel numbers are usually multiples of 8. A plurality of neural networks with different channel numbers may be constructed, and the neural network structures obtained in this case may be used as special effect rendering models to be selected. The special effect rendering models to be selected may be deployed and run on the terminal device so as to determine the amount of computation of each fusion special effect model to be selected. The processing effect may be obtained by setting model parameters in all special effect rendering models to be selected as default values, and inputting the same image separately into the models to obtain output results corresponding to the special effect rendering models to be selected, thereby determining similarities between the output results and a theoretically desired image. A special effect rendering model to be selected of the target network structure is determined based on a comprehensive evaluation of the similarity and the amount of computation, and the special effect rendering model to be selected is used as the special effect rendering model to be trained. Optionally, weights respectively corresponding to the amount of computation and the similarity are set and determined based on corresponding computation results. Generally, the weight of the similarity may be set higher so as to optimize the special effect after processing by the selected special effect rendering model to be trained.

It may be understood that in order to obtain a real-time mobile terminal model, an efficient structural design that requires a lower computational cost and a smaller number of parameters is searched for automatically by means of neutral architecture search (NAS). A network structure search method is used to automatically select channel widths in a generator to remove redundancy. That is, after the network structure is determined, the network structure may be deployed and run on the terminal device so as to determine the amount of computation, and under the condition that model parameters corresponding to various network structures are adjusted to be unified, an image is input. The special effect rendering model to be trained of the target network structure may be determined based on the similarities between the output images and the actual required image.

S320: Determine a master training special effect rendering model and a slave training special effect rendering model based on the special effect rendering model to be trained.

For example, after special effect rendering model to be trained of the target network structure is obtained, in order to make the result output by the obtained model more accurate, the master training special effect rendering model and the slave training special effect rendering model may be constructed based on the model structure.

Optionally, the master training special effect rendering model with a multiplied number of channels of the corresponding convolution is constructed based on a number of channels of each convolution in the special effect rendering model to be trained. The special effect rendering model to be trained is used as the slave training special effect rendering model.

It may be understood that, in order to obtain a more effective small mobile terminal model, an online distillation algorithm may be employed to improve the performance of the small model. In the process of model training, a master training special effect rendering model corresponding to a fusion special effect model to be trained is constructed. The master training fusion special effect model may be a model obtained by multiplying a number of channels of each convolution based on the special effect rendering model to be trained. It may be understood that the master special effect rendering model to be trained requires a large amount of computation, such that corresponding model parameters can be corrected based on a result output by the model, thereby optimizing the accuracy and effectiveness of the obtained model. The determined special effect rendering model to be trained is used as the slave training special effect rendering model. The master training special effect rendering model has a better output result, and when parameters of the slave training special effect rendering model are corrected based on the output result, an output result from the slave training special effect rendering model may be improved. The deployment of the slave training special effect rendering model on the terminal device may not only enable a good output result, but also achieve a light weight, thereby achieving a good adaptability with the terminal device.

S330: Obtain the target special effect rendering model by training the master training special effect rendering model and the slave training special effect rendering model.

The target special effect rendering model is the finally used special effect fusion model, which may add a most suitable target special effect based on the facial attribute of the target subject in the input image to be processed.

In this embodiment, the obtaining the target special effect rendering model by training the master training special effect rendering model and the slave training special effect rendering model includes:
obtaining a training sample set, where the training sample set includes a plurality of training sample types each corresponding to different facial attribute information, each training sample includes an original training image and a special effect superimposed image corresponding to the same facial attribute information, and the facial attribute information corresponds to a face deviation angle; inputting, for each training sample, the original training image in the current training sample separately into the master training special effect rendering model and the slave training special effect rendering model, to obtain a first special effect image and a second special effect image, where the first special effect image is an image output based on the master training special effect rendering model, and the second special effect image is an image output based on the slave training special effect rendering model; performing, based on loss functions for the master training special effect rendering model and the slave training special effect rendering model, loss processing on the first special effect image, the second special effect image, and the special effect superimposed image to obtain loss values, so as to correct model parameters in the master training special effect rendering model and the slave training special effect rendering model based on the loss values; using convergence in the loss functions as a training objective, to obtain a master special effect rendering model and a slave special effect rendering model; and using the trained slave special effect rendering model as the target special effect rendering model. In order to improve the accuracy of the model as much as possible, the corresponding training samples may be obtained as many and rich as possible. A set of all the training samples is used as the training sample set. The training sample set includes the plurality of training sample types. Each training sample type corresponds to different facial attribute information. Each training sample includes the original training image and the special effect superimposed image corresponding to the same facial attribute information. The original training image is the image just obtained, where there is no special effect in this image. The original training image may be obtained in a variety of ways. For example, the original training image may be determined based on a pre-trained face construction model, or based on facial information captured by a camera apparatus. The special effect superimposed image is the corresponding image after the special effect is added to the original training image. The first special effect image is the image output based on the master training special effect rendering model, and the second special effect image is the image output based on the slave training special effect rendering model.

It should be noted that the training samples are processed in the same manner, and therefore, the processing of one of the training samples is described as an example. In this case, the model parameters in the master training special effect rendering model and the slave training special effect rendering model are default values, which need to be corrected through training.

For example, after the training sample set is obtained, the original training image in the current training sample may be input to the master training special effect rendering model and the slave training special effect rendering model, such that the first special effect image and the second special effect image may be output. The loss processing is performed on the first special effect image, the second special effect image, and the special effect superimposed image based on the loss function to obtain the loss values, and the model parameters in the master training special effect rendering model and the slave training special effect rendering model may be corrected based on the loss values. When it is detected that the loss functions in the master training special effect rendering model and the slave training special effect rendering model converge, a master special effect fusion model and a slave special effect fusion model are determined. In order to achieve universality of deployment on terminal devices, the master special effect fusion model may be eliminated to obtain the target special effect rendering model. That is, the trained slave special effect rendering model is used as the target special effect rendering model.

It should be further noted that in this embodiment, obtaining the training sample corresponding to each training sample type may include: determining a training sample type of the current training sample; obtaining the original training image consistent with the training sample type, and reconstructing a fusion special effect model to be selected that is consistent with the training sample type; fusing the special effect model to be fused and a face image in the original training image to obtain the special effect superimposed image corresponding to the original training image; and using the original training image and the special effect superimposed image as one training sample.

For example, determining the sample type of the current training sample is determining deflection angle information of the face image in the current training sample. Based on this, the original training image corresponding to the training sample type may be captured based on the camera apparatus. Alternatively, a plurality of original training images including facial information may be constructed based on a pre-trained face construction model. In addition, the fusion special effect model to be selected is constructed based on the 3D rendering technology, which is consistent with the facial attribute information, i.e., consistent with the training sample type. The special effect superimposed image is obtained by fusion. The special effect superimposed image and the original training image is used as one training sample.

S340: Obtain, in response to a special effect trigger operation, an image to be processed that includes a target subject.

S350: Process the input image to be processed based on the pre-trained target special effect rendering model, determine the facial attribute information of the image to be processed, and fuse the target special effect consistent with the facial attribute information and the image to be processed to obtain the target special effect image.

For example, the image to be processed is input into the target special effect rendering model, the facial attribute information may be determined based on the target special effect rendering model, and the target special effect consistent with the facial information and the image to be processed may be fused to obtain the target special effect image.

Based on the foregoing, it can be known that in the technical solution of this embodiment of the present disclosure, 3D rendering may be used (to pre-construct the special effect fusion models to be selected), the image to be processed that includes a human face may be obtained, and a generative adversarial network (GAN) model (the target special effect rendering model) may be pre-trained such that a real-time special effect like the human face of a user to a “cat-woman” can be achieved. A head rendering special effect is provided based on requirements, and such a head rendering special effect is similar to a head special effect of a real animal, where the hair is clearly visible in this special effect, i.e., consistent with the hair of the real animal. Based on the 3D rendering technology, special effect fusion models corresponding to different facial perspectives are rendered. Through the face fusion technology, facial fusion is performed on the 3D special effect fusion model and real face data, i.e., the real face is fused into the model image, thereby obtaining paired sample data. The corresponding model is trained based on the paired sample data. The face image and the special effect fusion model have the same corresponding facial attribute information when they are fused together, i.e., the face image and the special effect fusion model correspond to the same face deflection angle.

The technical solution of this embodiment of the present disclosure may be applied to support various special effects of combining real facial features with head rendering, without being limited to the “cat-woman” effect shown in the technical solution.

In the technical solution of this embodiment of the present disclosure, the pre-trained special effect rendering model may be deployed on the mobile terminal, such that when the image to be processed is acquired, the image can be processed quickly based on the model to obtain the target special effect image with the corresponding special effect, thereby achieving the technical effect of improving convenience and reality of special effect processing.

### Embodiment 4

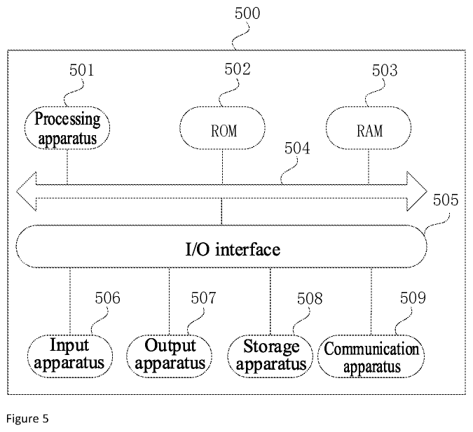

FIG. 4 is a schematic diagram of a structure of an image processing apparatus according to Embodiment 4 of the present disclosure. The apparatus includes: an image-to-be-processed acquisition module 410 and a special effect image determining module 420.

The image-to-be-processed acquisition module 410 is configured to obtain, in response to a special effect trigger operation, an image to be processed that includes a target subject. The special effect image determining module 420 is configured to determine facial attribute information of the target subject, and fuse a target special effect matching the facial attribute information for the target subject, to obtain a target special effect image corresponding to the image to be processed.

On the basis of the above technical solution, the special effect trigger operation includes at least one of the following:
triggering a special effect processing control; detecting that a display interface includes a face image; detecting voice information including a special effect adding instruction; and detecting that, in a field of view corresponding to a target terminal, a body movement of the target subject is the same as a preset special effect feature.

On the basis of the above technical solutions, the facial attribute information includes at least face deflection angle information, and the special effect image determining module includes: a facial attribute determining unit configured to determine face deflection angle information of a face image of the target subject relative to a display device.

On the basis of the above technical solutions, the facial attribute determining unit is configured to:
determine, based on a predetermined target center line, a deflection angle of the face image relative to the target center line, and use the deflection angle as the face deflection angle information, where the target center line is determined based on a historical face image, and a face deflection angle of the historical face image relative to the display device is less than a preset deflection angle threshold; or
segment the face image based on a preset grid, and determine the face deflection angle information of the face image relative to the display device based on a segmentation result; or perform angle registration on the face image and all face images to be matched, to determine a target face image to be matched that corresponds to the face image, and use a face deflection angle of the target face image to be matched as the face deflection angle of the target subject, where all the face images to be matched respectively correspond to different deflection angles, and a set of the different deflection angles covers 360 degrees; or
recognize, based on a pre-trained face deflection angle determining model, the face image in the image to be processed to determine the face deflection angle of the target subject.

On the basis of the above technical solutions, the special effect image determining module includes: a special effect determining unit configured to obtain a target fusion special effect model consistent with the facial attribute information from all fusion special effect models to be selected, where all the fusion models to be selected respectively correspond to different face deflection angles and are consistent with the target special effect; and a special effect fusing unit configured to fuse the target fusion special effect model and the face image of the target subject to obtain the target special effect image in which the target special effect is fused for the target subject.

On the basis of the above technical solutions, the special effect fusing unit is further configured to extract a head image of the target subject, and fuse the head image into a target position in the target fusion special effect model to obtain a special effect image to be corrected, where the head image includes the face image and a hair image; and determine pixels to be corrected in the special effect image to be corrected, and process the pixels to be corrected to obtain the target special effect image, where the pixels to be corrected include pixels corresponding to a hair area that is not covered by the target special effect and pixels on an edge of the face image that do not fit a target fusion special effect.

On the basis of the above technical solutions, the special effect fusing unit is further configured to determine at least one fusion key point in the target fusion special effect model and a corresponding target key point on the face image, to obtain at least one key point pair; and
determine a distortion parameter based on the at least one key point pair, so as to adapt the target fusion special effect model to the face image based on the distortion parameter, to obtain the target special effect image.

On the basis of the above technical solutions, the special effect image determining module is further configured to: process the input image to be processed based on a pre-trained target special effect rendering model, determine the facial attribute information of the image to be processed, and render the target special effect consistent with the facial attribute information to obtain the target special effect image.

On the basis of the above technical solutions, the special effect image determining module further includes: a model structure determining unit configured to determine a special effect rendering model to be trained of a target network structure;
a rendering model determining unit configured to determine a master training special effect rendering model and a slave training special effect rendering model based on the special effect rendering model to be trained; and
a target special effect rendering model determining unit configured to obtain the target special effect rendering model by training the master training special effect rendering model and the slave training special effect rendering model.

On the basis of the above technical solutions, the model structure determining unit is further configured to: obtain at least one neural network to be selected, where the neural network to be selected includes a convolutional layer, and the convolutional layer includes at least one convolution each including a plurality of channel numbers; and
determine, based on an amount of computation and an image processing effect of the at least one neural network to be selected, a neural network to be selected of the target network structure as the special effect rendering model to be trained,
where the image processing effect is evaluated by a similarity between an output image and an actual image under a condition that model parameters in the at least one neural network to be selected are unified.

On the basis of the above technical solutions, the rendering model determining unit is further configured to: construct, based on a number of channels of each convolution in the special effect rendering model to be trained, the master training special effect rendering model with a multiplied number of channels of the corresponding convolution; and
use the special effect rendering model to be trained as the slave training special effect rendering model.

On the basis of the above technical solutions, the target special effect rendering model determining unit is further configured to: obtain a training sample set, where the training sample set includes a plurality of training sample types each corresponding to different facial attribute information, each training sample includes an original training image and a special effect superimposed image corresponding to the same facial attribute information, and the facial attribute information corresponds to a face deviation angle; input, for each training sample, the original training image in the current training sample separately into the master training special effect rendering model and the slave training special effect rendering model, to obtain a first special effect image and a second special effect image, where the first special effect image is an image output based on the master training special effect rendering model, and the second special effect image is an image output based on the slave training special effect rendering model; perform, based on loss functions for the master training special effect rendering model and the slave training special effect rendering model, loss processing on the first special effect image, the second special effect image, and the special effect superimposed image to obtain loss values, so as to correct model parameters in the master training special effect rendering model and the slave training special effect rendering model based on the loss values; use convergence in the loss functions as a training objective, to obtain a master special effect rendering model and a slave special effect rendering model; and use the trained slave special effect rendering model as the target special effect rendering model.

On the basis of the above technical solutions, the target special effect rendering model determining unit is further configured to: determine a training sample type of the current training sample; obtain the original training image consistent with the training sample type, and reconstruct a fusion special effect model to be selected that is consistent with the training sample type; fuse the fusion special effect model to be selected and a face image in the original training image to obtain the special effect superimposed image corresponding to the original training image; and use the original training image and the special effect superimposed image as one training sample.

On the basis of the above technical solutions, the target special effect includes at least one of a pet head simulation special effect, an animal head simulation special effect, a cartoon image simulation special effect, a fluff simulation special effect, and a hairstyle simulation special effect to be fused with the face image.

The image processing apparatus provided in this embodiment of the present disclosure can perform the image processing method provided in any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, the names of the functional units are merely used for mutual distinguishing.

### Embodiment 5

FIG. 5 is a schematic diagram of a structure of an electronic device according to Embodiment 5 of the present disclosure. Reference is made to FIG. 5 below, which is a schematic diagram of a structure of an electronic device (such as a terminal device or a server in FIG. 5) 500 suitable for implementing an embodiment of the present disclosure. The terminal device in this embodiment of the present disclosure may include a mobile terminal such as a mobile phone, a notebook computer, a digital broadcast receiver, a personal digital assistant (PDA), a tablet computer (Portable Android Device, PAD), a portable media player (PMP), and a vehicle-mounted terminal (such as a vehicle navigation terminal), and a fixed terminal such as a digital television (i.e., a digital TV) and a desktop computer. The electronic device shown in FIG. 5 is merely an example.

As shown in FIG. 5, the electronic device 500 may include a processing apparatus (e.g., a central processor, a graphics processor) 501 that may perform a variety of appropriate actions and processing in accordance with a program stored in a read-only memory (ROM) 502 or a program loaded from a storage apparatus 506 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 506 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In an embodiment, the processes described above with reference to the flowcharts may be implemented as a computer software program according to this embodiment of the present disclosure. For example, this embodiment of the present disclosure includes a computer program product, which includes a computer program carried on a non-transitory computer-readable medium, where the computer program includes program code for performing the methods shown in the flowcharts. In such an embodiment, the computer program may be downloaded from a network through the communication apparatus 509 and installed, installed from the storage apparatus 506, or installed from the ROM 502. When the computer program is executed by the processing apparatus 501, the above functions defined in the method of the embodiment of the present disclosure are performed.

The electronic device provided in this embodiment of the present disclosure and the image processing methods provided in the above embodiments belong to the same concept. For the technical details not described in detail in this embodiment, reference can be made to the above embodiments, and this embodiment and the above embodiments have the same beneficial effects.

### Embodiment 6

This embodiment of the present disclosure provides a computer storage medium having stored thereon a computer program that, when executed by a processor, causes the image processing methods provided in the above embodiments to be implemented.

It should be noted that the above computer-readable medium described in the present disclosure may be a computer-readable signal medium, a computer-readable storage medium, or a combination thereof. The computer-readable storage medium may be, for example, electric, magnetic, optical, electromagnetic, infrared, or semiconductor systems, apparatuses, or devices, or a combination thereof. Examples of the computer-readable storage medium may include: an electrical connection having at least one wire, a portable computer disk, a hard disk, a random access memory (RAM), a read-only memory (ROM), an erasable programmable read-only memory (such as an electronic programmable read-only memory (EPROM) or flash memory), an optical fiber, a portable compact disc read-only memory (CD-ROM), an optical storage device, a magnetic storage device, or a suitable combination thereof. In the present disclosure, the computer-readable storage medium may be a tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including an electromagnetic signal, an optical signal, or a suitable combination thereof. The computer-readable signal medium may also be a computer-readable medium other than the computer-readable storage medium. The computer-readable signal medium can send, propagate, or transmit a program used by or in combination with an instruction execution system, apparatus, or device. The program code contained in the computer-readable medium may be transmitted by a suitable medium, including: electric wires, optical cables, radio frequency (RF), etc., or a suitable combination thereof.

In some implementations, a client and a server can communicate using a currently known or future-developed network protocol such as HyperText Transfer Protocol (HTTP), and may be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and a currently known or future-developed network.

The above computer-readable medium may be contained in the above electronic device. Alternatively, the computer-readable medium may exist independently, without being assembled into the electronic device.

The above computer-readable medium carries a program that, when executed by the electronic device, causes the electronic device to:
acquire an image to be processed that includes a target object, and process a special effect part to be processed of the target object into a first special effect to obtain a first special effect display image; and
enlarge the first special effect display image for display, and process, when it is detected that an enlargement stop condition is met, a special effect part to be adjusted in the first special effect display image into a second special effect, so as to obtain a second special effect display image.

Computer program code for performing operations of the present disclosure can be written in one or more programming languages or a combination thereof, where the programming languages include object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and the block diagram in the drawings illustrate the possibly implemented architecture, functions, and operations of the system, method, and computer program product according to various embodiments of the present disclosure. In this regard, each block in the flowcharts or block diagram may represent a module, program segment, or part of code, and the module, program segment, or part of code contains at least one executable instruction for implementing the specified logical functions. It should also be noted that, in some alternative implementations, the functions marked in the blocks may also occur in an order different from that marked in the drawings. For example, two blocks shown in succession can actually be performed substantially in parallel, or they can sometimes be performed in the reverse order, depending on the functions involved. It should also be noted that each block in the block diagram and/or the flowcharts, and a combination of the blocks in the block diagram and/or the flowcharts may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. Names of the units do not constitute a limitation on the units themselves in some cases. For example, a first obtaining unit may alternatively be described as “a unit for obtaining at least two Internet Protocol addresses”.

The functions described herein above may be performed at least partially by at least one hardware logic component. For example, exemplary types of hardware logic components that may be used include: a field-programmable gate array (FPGA), an application-specific integrated circuit (ASIC), application-specific standard parts (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or a suitable combination thereof. Examples of the machine-readable storage medium may include an electrical connection based on at least one wire, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or a suitable combination thereof.

According to one or more embodiments of the present disclosure, [Example 1] provides an image processing method, and the method includes:
obtaining, in response to a special effect trigger operation, an image to be processed that includes a target subject; and
determining facial attribute information of the target subject, and fusing a target special effect matching the facial attribute information for the target subject, to obtain a target special effect image corresponding to the image to be processed.

According to one or more embodiments of the present disclosure, [Example 2] provides an image processing method, and the method further includes the following step.

Optionally, the special effect trigger operation includes at least one of the following:
triggering a special effect processing control;
detecting that a display interface includes a face image;
detecting voice information including a special effect adding instruction; and
detecting that, in a field of view corresponding to a target terminal, a body movement of the target subject is the same as a preset special effect feature.

According to one or more embodiments of the present disclosure, [Example 3] provides an image processing method, and the method further includes the following step.

Optionally, the determining facial attribute information of the target subject includes:
the facial attribute information includes at least face deflection angle information, and the determining facial attribute information of the target subject includes:
determining face deflection angle information of a face image of the target subject relative to a display device.

According to one or more embodiments of the present disclosure, [Example 4] provides an image processing method, and the method further includes the following step.

Optionally, the determining face deflection angle information of a face image of the target subject relative to a display device includes:
determining, based on a predetermined target center line, a deflection angle of the face image relative to the target center line, and using the deflection angle as the face deflection angle information, where the target center line is determined based on a historical face image, and a face deflection angle of the historical face image relative to the display device is less than a preset deflection angle threshold; or
segmenting the face image based on a preset grid, and determining the face deflection angle information of the face image relative to the display device based on a segmentation result; or performing angle registration on the face image and all face images to be matched, to determine a target face image to be matched that corresponds to the face image, and using a face deflection angle of the target face image to be matched as the face deflection angle information of the target subject, where all the face images to be matched respectively correspond to different deflection angles, and a set of the different deflection angles covers 360 degrees; or
recognizing, based on a pre-trained face deflection angle determining model, the image to be processed to determine the face deflection angle information of the target subject.

According to one or more embodiments of the present disclosure, [Example 5] provides an image processing method, and the method further includes the following step.

Optionally, the fusing a target special effect consistent with the facial attribute information for the target subject, to obtain a target special effect image corresponding to the image to be processed includes:
obtaining a target fusion special effect model consistent with the facial attribute information from all fusion special effect models to be selected, where all the fusion models to be selected respectively correspond to different face deflection angles and are consistent with the target special effect; and
fusing the target fusion special effect model and the face image of the target subject to obtain the target special effect image in which the target special effect is fused for the target subject.

According to one or more embodiments of the present disclosure, [Example 6] provides an image processing method, and the method further includes the following step.

Optionally, the fusing the target fusion special effect model and the face image of the target subject to obtain the target special effect image in which the target special effect is fused for the target subject includes:
extracting a head image of the target subject, and fusing the head image into a target position in the target fusion special effect model to obtain a special effect image to be corrected, where the head image includes the face image and a hair image; and
determining pixels to be corrected in the special effect image to be corrected, and processing the pixels to be corrected to obtain the target special effect image, where the pixels to be corrected include pixels corresponding to a hair area that is not covered by the target special effect and pixels on an edge of the face image that do not fit a target fusion special effect.

According to one or more embodiments of the present disclosure, [Example 7] provides an image processing method, and the method further includes the following step.

Optionally, the fusing the target fusion special effect model and the face image of the target subject to obtain the target special effect image in which the target special effect is fused for the target subject includes:
determining at least one fusion key point in the target fusion special effect model and a corresponding target key point on the face image, to obtain at least one key point pair; and
determining a distortion parameter based on the at least one key point pair, so as to adapt the target fusion special effect model to the face image based on the distortion parameter, to obtain the target special effect image.

According to one or more embodiments of the present disclosure, [Example 8] provides an image processing method, and the method further includes the following step.

Optionally, the determining facial attribute information of the target subject, and fusing a target special effect matching the facial attribute information for the target subject, to obtain a target special effect image corresponding to the image to be processed includes:
processing the input image to be processed based on a pre-trained target special effect rendering model, determining the facial attribute information of the image to be processed, and rendering the target special effect consistent with the facial attribute information to obtain the target special effect image.

According to one or more embodiments of the present disclosure, [Example 9] provides an image processing method, and the method further includes:
optionally, determining a special effect rendering model to be trained of a target network structure;
determining a master training special effect rendering model and a slave training special effect rendering model based on the special effect rendering model to be trained; and
obtaining the target special effect rendering model by training the master training special effect rendering model and the slave training special effect rendering model.

According to one or more embodiments of the present disclosure, [Example 10] provides an image processing method, and the method further includes the following step.

Optionally, the determining a special effect rendering model to be trained of a target network structure includes:
obtaining at least one neural network to be selected, where the neural network to be selected includes a convolutional layer, and the convolutional layer includes at least one convolution each including a plurality of channel numbers; and
determining, based on an amount of computation and an image processing effect of the at least one neural network to be selected, a neural network to be selected of the target network structure as the special effect rendering model to be trained,
where the image processing effect is evaluated by a similarity between an output image and an actual image under a condition that model parameters in the at least one neural network to be selected are unified.

According to one or more embodiments of the present disclosure, [Example 11] provides an image processing method, and the method further includes the following step.

Optionally, the determining a master training special effect rendering model and a slave training special effect rendering model based on the special effect rendering model to be trained includes:
constructing, based on a number of channels of each convolution in the special effect rendering model to be trained, the master training special effect rendering model with a multiplied number of channels of the corresponding convolution; and
using the special effect rendering model to be trained as the slave training special effect rendering model.

According to one or more embodiments of the present disclosure, [Example 12] provides an image processing method, and the method further includes the following step.

Optionally, the obtaining the target special effect rendering model by training the master training special effect rendering model and the slave training special effect rendering model includes:
obtaining a training sample set, where the training sample set includes a plurality of training sample types each corresponding to different facial attribute information, each training sample includes an original training image and a special effect superimposed image corresponding to the same facial attribute information, and the facial attribute information corresponds to a face deviation angle;
inputting, for each training sample, the original training image in the current training sample separately into the master training special effect rendering model and the slave training special effect rendering model, to obtain a first special effect image and a second special effect image, where the first special effect image is an image output based on the master training special effect rendering model, and the second special effect image is an image output based on the slave training special effect rendering model;
performing, based on loss functions for the master training special effect rendering model and the slave training special effect rendering model, loss processing on the first special effect image, the second special effect image, and the special effect superimposed image to obtain loss values, so as to correct model parameters in the master training special effect rendering model and the slave training special effect rendering model based on the loss values;
using convergence in the loss functions as a training objective, to obtain a master special effect rendering model and a slave special effect rendering model; and
using the trained slave special effect rendering model as the target special effect rendering model.

According to one or more embodiments of the present disclosure, [Example 13] provides an image processing method, and the method further includes the following step.

Optionally, determining the original training image and the special effect superimposed image in each training sample includes:
determining a training sample type of the current training sample;
obtaining the original training image consistent with the training sample type, and reconstructing a fusion special effect model to be selected that is consistent with the training sample type;
fusing the fusion special effect model to be selected and a face image in the original training image to obtain the special effect superimposed image corresponding to the original training image; and
using the original training image and the special effect superimposed image as one training sample.

According to one or more embodiments of the present disclosure, [Example 14] provides an image processing method, and the method further includes the following step.

Optionally, the target special effect includes at least one of a pet head simulation special effect, an animal head simulation special effect, a cartoon image simulation special effect, a fluff simulation special effect, and a hairstyle simulation special effect to be fused with the face image.

According to one or more embodiments of the present disclosure, [Example 15] provides an image processing apparatus, and the apparatus includes:
an image-to-be-processed acquisition module configured to obtain, in response to a special effect trigger operation, an image to be processed that includes a target subject; and
a special effect image determining module configured to determine facial attribute information of the target subject, and fuse a target special effect matching the facial attribute information for the target subject, to obtain a target special effect image corresponding to the image to be processed.

1. An image processing method, comprising:
obtaining, in response to a special effect trigger operation, an image to be processed that comprises a target subject; and
determining facial attribute information of the target subject, and fusing a target special effect matching the facial attribute information for the target subject, to obtain a target special effect image corresponding to the image to be processed.

2. The method according to claim 1, wherein the special effect trigger operation comprises at least one of the following:
triggering a special effect processing control;
detecting voice information comprising a special effect adding instruction;
detecting that a display interface comprises a face image; and
detecting that, in a field of view corresponding to a target terminal, a body movement of the target subject is the same as a preset special effect feature.

3. The method according to claim 1, wherein the facial attribute information comprises at least face deflection angle information, and the determining facial attribute information of the target subject comprises:
determining face deflection angle information of a face image of the target subject relative to a display device.

4. The method according to claim 3, wherein the determining face deflection angle information of a face image of the target subject relative to a display device comprises:
determining, based on a predetermined target center line, a deflection angle of the face image relative to the target center line, and using the deflection angle as the face deflection angle information, wherein the target center line is determined based on a historical face image, and a face deflection angle of the historical face image relative to the display device is less than a preset deflection angle threshold; or
segmenting the face image based on a preset grid, and determining the face deflection angle information of the face image relative to the display device based on a segmentation result; or
performing angle registration on the face image and all face images to be matched, to determine a target face image to be matched that corresponds to the face image, and using a face deflection angle of the target face image to be matched as the face deflection angle information of the target subject, wherein all the face images to be matched respectively correspond to different deflection angles, and a set of the different deflection angles covers 360 degrees; or
recognizing, based on a pre-trained face deflection angle determining model, the image to be processed to determine the face deflection angle information of the target subject.

5. The method according to claim 4, wherein the fusing a target special effect matching the facial attribute information for the target subject, to obtain a target special effect image corresponding to the image to be processed comprises:
obtaining a target fusion special effect model consistent with the facial attribute information from all fusion special effect models to be selected, wherein all the fusion special effect models to be selected are special effect models respectively corresponding to different face deflection angles; and
fusing the target fusion special effect model and the face image of the target subject to obtain the target special effect image in which the target special effect is fused for the target subject.

6. The method according to claim 5, wherein the fusing the target fusion special effect model and the face image of the target subject to obtain the target special effect image in which the target special effect is fused for the target subject comprises:
extracting a head image of the target subject, and fusing the head image into a target position in the target fusion special effect model to obtain a special effect image to be corrected, wherein the head image comprises the face image and a hair image; and
determining pixels to be corrected in the special effect image to be corrected, and processing the pixels to be corrected to obtain the target special effect image, wherein the pixels to be corrected comprise pixels corresponding to a hair area that is not covered by the target special effect and pixels on an edge of the face image that do not fit a target fusion special effect.

7. The method according to claim 5, wherein the fusing the target fusion special effect model and the face image of the target subject to obtain the target special effect image in which the target special effect is fused for the target subject comprises:
determining at least one fusion key point in the target fusion special effect model and a corresponding target key point on the face image, to obtain at least one key point pair; and
determining a distortion parameter based on the at least one key point pair, so as to adapt the target fusion special effect model to the face image based on the distortion parameter, to obtain the target special effect image.

8. The method according to claim 1, wherein the determining facial attribute information of the target subject, and fusing a target special effect matching the facial attribute information for the target subject, to obtain a target special effect image corresponding to the image to be processed comprises:
processing the input image to be processed based on a pre-trained target special effect rendering model, determining the facial attribute information of the image to be processed, and rendering the target special effect consistent with the facial attribute information to obtain the target special effect image.

9. The method according to claim 8, wherein the method further comprises:
determining a special effect rendering model to be trained of a target network structure;
determining a master training special effect rendering model and a slave training special effect rendering model based on the special effect rendering model to be trained; and
obtaining the target special effect rendering model by training the master training special effect rendering model and the slave training special effect rendering model.

10. The method according to claim 9, wherein the determining a special effect rendering model to be trained of a target network structure comprises:
obtaining at least one neural network to be selected, wherein the neural network to be selected comprises a convolutional layer, and the convolutional layer comprises at least one convolution each comprising a plurality of channel numbers; and
determining, based on an amount of computation and an image processing effect of the at least one neural network to be selected, a neural network to be selected of the target network structure as the special effect rendering model to be trained,
wherein the image processing effect is evaluated by a similarity between an output image and an actual image under a condition that model parameters in the at least one neural network to be selected are unified.

11. The method according to claim 9, wherein the determining a master training special effect rendering model and a slave training special effect rendering model based on the special effect rendering model to be trained comprises:
constructing, based on a number of channels of each convolution in the special effect rendering model to be trained, the master training special effect rendering model with a multiplied number of channels of the corresponding convolution; and
using the special effect rendering model to be trained as the slave training special effect rendering model.

12. The method according to claim 9, wherein the obtaining the target special effect rendering model by training the master training special effect rendering model and the slave training special effect rendering model comprises:
obtaining a training sample set, wherein the training sample set comprises a plurality of training sample types each corresponding to different facial attribute information, each training sample comprises an original training image and a special effect superimposed image corresponding to the same facial attribute information, and the facial attribute information corresponds to a face deviation angle;
inputting, for each training sample, the original training image in the current training sample separately into the master training special effect rendering model and the slave training special effect rendering model, to obtain a first special effect image and a second special effect image, wherein the first special effect image is an image output based on the master training special effect rendering model, and the second special effect image is an image output based on the slave training special effect rendering model;
performing, based on loss functions for the master training special effect rendering model and the slave training special effect rendering model, loss processing on the first special effect image, the second special effect image, and the special effect superimposed image to obtain loss values, so as to correct model parameters in the master training special effect rendering model and the slave training special effect rendering model based on the loss values;
using convergence in the loss functions as a training objective, to obtain a master special effect rendering model and a slave special effect rendering model; and
using the trained slave special effect rendering model as the target special effect rendering model.

13. The method according to claim 12, wherein determining the original training image and the special effect superimposed image in each training sample comprises:
determining a training sample type of the current training sample;
obtaining the original training image consistent with the training sample type, and reconstructing a fusion special effect model to be selected that is consistent with the training sample type;
fusing the fusion special effect model to be selected and a face image in the original training image to obtain the special effect superimposed image corresponding to the original training image; and
using the original training image and the special effect superimposed image as one training sample.

14. The method according to claim 1, wherein the target special effect comprises at least one of a pet head simulation special effect, an animal head simulation special effect, a cartoon image simulation special effect, a fluff simulation special effect, and a hairstyle simulation special effect to be fused with the face image.

15. (canceled)

16. An electronic device, comprising:
a processor; and
a storage apparatus configured to store a program, wherein
the program, when executed by the processor, causes the processor to:
obtain, in response to a special effect trigger operation, an image to be processed that comprises a target subject; and
determine facial attribute information of the target subject, and fusing a target special effect matching the facial attribute information for the target subject, to obtain a target special effect image corresponding to the image to be processed.

17. (canceled)

18. A computer program product which, when executed by a computer, causes the computer to:
obtain, in response to a special effect trigger operation, an image to be processed that comprises a target subject; and
determine facial attribute information of the target subject, and fusing a target special effect matching the facial attribute information for the target subject, to obtain a target special effect image corresponding to the image to be processed.

19. The device according to claim 16, wherein the special effect trigger operation comprises at least one of the following:
triggering a special effect processing control;
detecting voice information comprising a special effect adding instruction;
detecting that a display interface comprises a face image; and
detecting that, in a field of view corresponding to a target terminal, a body movement of the target subject is the same as a preset special effect feature.

20. The device according to claim 16, wherein the facial attribute information comprises at least face deflection angle information, and the determining facial attribute information of the target subject comprises:
determining face deflection angle information of a face image of the target subject relative to a display device.

21. The device according to claim 20, wherein the determining face deflection angle information of a face image of the target subject relative to a display device comprises:
determining, based on a predetermined target center line, a deflection angle of the face image relative to the target center line, and using the deflection angle as the face deflection angle information, wherein the target center line is determined based on a historical face image, and a face deflection angle of the historical face image relative to the display device is less than a preset deflection angle threshold; or
segmenting the face image based on a preset grid, and determining the face deflection angle information of the face image relative to the display device based on a segmentation result; or
performing angle registration on the face image and all face images to be matched, to determine a target face image to be matched that corresponds to the face image, and using a face deflection angle of the target face image to be matched as the face deflection angle information of the target subject, wherein all the face images to be matched respectively correspond to different deflection angles, and a set of the different deflection angles covers 360 degrees; or
recognizing, based on a pre-trained face deflection angle determining model, the image to be processed to determine the face deflection angle information of the target subject.

22. The device according to claim 21, wherein the fusing a target special effect matching the facial attribute information for the target subject, to obtain a target special effect image corresponding to the image to be processed comprises:
obtaining a target fusion special effect model consistent with the facial attribute information from all fusion special effect models to be selected, wherein all the fusion special effect models to be selected are special effect models respectively corresponding to different face deflection angles; and
fusing the target fusion special effect model and the face image of the target subject to obtain the target special effect image in which the target special effect is fused for the target subject.
